(19) United States
(12) Patent Application Publication
(10) Pub. No.: US 2017/0068038 A1
(43) Pub. Date: Mar. 9, 2017

(54) INTEGRATED BACK LIGHT UNIT

(71) Applicant: GLO AB, Lund (SE)

(72) Inventors: Fariba DANESH, Pleasanton, CA (US); Michael JANSEN, Palo Alto, CA (US); Clinton CARLISLE, Sunnyvale, CA (US); Ping WANG, Sunnyvale, CA (US)

(21) Appl. No.: 15/353,050

(22) Filed: Nov. 16, 2016

Related U.S. Application Data
(63) Continuation-in-part of application No. PCT/US2015/044488, filed on Aug. 10, 2015.
Application No. PCT/US2015/044488 is a continuation-in-part of application No. 14/493,129, filed on Sep. 22, 2014.
(60) Provisional application No. 62/036,420, filed on Aug. 12, 2014.
(60) Provisional application No. 62/049,523, filed on Sep. 12, 2014.
(60) Provisional application No. 62/096,247, filed on Dec. 23, 2014.
(60) Provisional application No. 62/169,795, filed on Jun. 2, 2015.
(60) Provisional application No. 61/881,037, filed on Sep. 23, 2013.
(60) Provisional application No. 61/894,466, filed on Oct. 23, 2013.
(60) Provisional application No. 61/905,587, filed on Nov. 18, 2013.
(60) Provisional application No. 62/035,872, filed on Aug. 11, 2014.
(60) Provisional application No. 62/256,247, filed on Nov. 17, 2015.

(51) Int. Cl. F21V 8/00

(52) U.S. Cl. CPC G02B 6/0025; G02B 6/0023; G02B 6/0038

(57) ABSTRACT

An integrated back light unit includes a light emitting device assembly which contains an optically transparent encapsulant portion which encapsulates at least one light emitting device, and a light guide unit optically coupled to the at least one light emitting device to receive light from the at least one light emitting device. An adhesive material portion can be provided to bond the light emitting device assembly and the light guide unit. Light-scattering particles can be provided in the optical path of the light from the at least one light emitting device to diffuse light and to homogenize the light introduced into the light guide unit. The light-scattering particles and the adhesive material portion can increase the coupling efficiency of the integrated back light unit.

### RELATED APPLICATIONS

This application is a continuation-in-part of PCT International Application No. PCT/US15/44488, filed Aug. 10, 2015, which claims priority from U.S. Provisional Patent Application No. 62/036,420, filed Aug. 12, 2014, 62/049,523, filed Sep. 12, 2014, 62/096,247, filed Dec. 23, 2014, and U.S. provisional application No. 62/169,795, filed Jun. 2, 2015, the entire contents of all of which are incorporated herein by reference. This application is also a continuation-in-part of U.S. application Ser. No. 14/493,129 filed Sep. 22, 2014, which claims priority from U.S. Provisional Patent Application No. 61/881,037, filed Sep. 23, 2013, 61/894,466, filed Oct. 23, 2013, 61/905,587, filed Nov. 18, 2013, and 62/035,872, filed Aug. 11, 2014, the entire contents of all of which are incorporated herein by reference. Further, this application claims the benefit of priority of U.S. Provisional Application No. 62/256,247 filed on Nov. 17, 2015, the entire contents of which are incorporated herein by reference.

### FIELD

The embodiments of the invention are directed generally to semiconductor light emitting devices, such as light emitting diodes (LED), and specifically an integrated back light LED unit.

### BACKGROUND

LEDs are used in electronic displays, such as liquid crystal displays in laptops or LED televisions. Conventional LED units are fabricated by mounting LEDs to a substrate, encapsulating the mounted LEDs and then optically coupling the encapsulated LEDs to an optical waveguide. The conventional LED units may suffer from poor optical coupling.

### SUMMARY

According to an aspect of the present disclosure, an integrated back light unit is provided, which comprises: a light emitting device assembly comprising a support containing an encapsulating matrix, at least one light emitting device located on the support, and at least one optically transparent encapsulant portion located on the at least one light emitting device, wherein the encapsulating matrix and the at least one optically transparent encapsulant portion encapsulate the at least one light emitting device, and the at least one light emitting device is configured to provide emission of light through the optically transparent encapsulant portion; a light guide unit optically coupled to the at least one light emitting device to receive light from the at least one light emitting device and having a proximal sidewall surface; and an adhesive material portion bonded to a surface of the light emitting device assembly and the proximal sidewall surface of the light guide unit.

According to another aspect of the present disclosure, an integrated back light unit is provided, which comprises: a light emitting device assembly comprising a support containing an encapsulating matrix, at least one light emitting device located on the support, and at least one optically transparent encapsulant portion located on the at least one light emitting device, wherein the encapsulating matrix and the at least one optically transparent encapsulant portion encapsulate the at least one light emitting device, and the at least one light emitting device is configured to provide emission of light through the optically transparent encapsulant portion; and a light guide unit optically coupled to the at least one light emitting device to receive light from the at least one light emitting device and having a proximal sidewall surface, wherein light-scattering particles are provided within an optical path between the at least one light emitting device and the light guide unit to diffuse rays of light propagating from the at least one light emitting device to the light guide unit.

According to yet another aspect of the present disclosure, an integrated back light unit is provided, which comprises: a light emitting device assembly comprising a support containing an encapsulating matrix, at least one light emitting device located on the support, and at least one optically transparent encapsulant portion located on the at least one light emitting device, wherein the encapsulating matrix and the at least one optically transparent encapsulant portion encapsulate the at least one light emitting device, and the at least one light emitting device is configured to provide emission of light through the optically transparent encapsulant portion; and a light guide unit optically coupled to the at least one light emitting device to receive light from the at least one light emitting device and having a proximal sidewall surface, wherein coupling efficiency of the integrated back light unit is at least 65%, wherein the coupling efficiency is a ratio of power received through the rays of light at a plane that is parallel to, and located 4 mm away from, the proximal sidewall surface of the light guide plate to power contained within photons generated from the at least one light emitting device in the absence of any light extraction features on the light guide plate, of the integrated back light unit is at least 65%.

According to still another aspect of the present disclosure, an integrated back light unit is provided, which comprises: a light emitting device assembly comprising a support containing an encapsulating matrix, at least one light emitting device located on the support, and at least one optically transparent encapsulant portion located on the at least one light emitting device, wherein the encapsulating matrix and the at least one optically transparent encapsulant portion encapsulate the at least one light emitting device, and the at least one light emitting device is configured to provide emission of light through the optically transparent encapsulant portion; and a light guide unit optically coupled to the at least one light emitting device to receive light from the at least one light emitting device and having a proximal sidewall surface, wherein light-scattering particles are provided within an optical path between the at least one light emitting device and the light guide unit to diffuse rays of light propagating from the at least one light emitting device to the light guide unit.

### BRIEF DESCRIPTION OF THE DRAWINGS

FIG. 1 is a schematic illustration of a top-down view of a first exemplary integrated back light unit according to a first embodiment of the present disclosure. The portion of the encapsulating matrix overlying a source-side reflection material layer, a lead structure, or leads are not shown for clarity.

FIG. 2 is a schematic illustration of a vertical cross-sectional view of the first exemplary integrated back light unit according to the first embodiment of the present disclosure.

FIG. 3 is a schematic illustration of a vertical cross-sectional view of a second exemplary integrated back light unit according to a second embodiment of the present disclosure.

FIG. 4 is a schematic illustration of a vertical cross-sectional view of an exemplary integrated set up for measuring coupling efficiency between a light emitting device and a light guide unit.

### DETAILED DESCRIPTION

The present inventors realized that prior art backlight solutions which utilize LED light sources and which are intended for uniform illumination applications, such as transmissive and reflective displays and thin profile panel luminaires suffer from degraded overall optical system efficiency due to one or more of the following limitations:
1. The inherent optical loss originating from the absorptive loss that stems from the package housing the LED emitters;
2. The etendue of the coupling optics among the LED emitters, LED package and the light guide plate;
3. The assembly tolerances in five degrees of freedom originating from the placement of the LED package, the air gap between the package and the light guide plate and the alignment of light guide plate to the LED package; and
4. The continuing desire to reduce the overall thickness of the backlighting units' thickness.
   The quest for slimmer light panels and thinner display, particularly in the mobile digital appliance markets, exacerbates the aforementioned challenges.

Throughout the drawings, like elements are described by the same reference numerals. The drawings are not drawn to scale. Multiple instances of an element may be duplicated where a single instance of the element is illustrated, unless absence of duplication of elements is expressly described or clearly indicated otherwise. Ordinals such as “first,” “second,” and “third” are employed merely to identify similar elements, and different ordinals may be employed across the specification and the claims of the instant disclosure.

As used herein, an “integrated back light unit” refers to a unit that provides the function of illumination for liquid crystal displays (LCDs) or other devices that display an image by blocking a subset of background illumination from the side or from the back. As used herein, a “light emitting device” can be any device that is capable of emitting light in the visible range (having a wavelength in a range from 400 nm to 800 nm), in the infrared range (having a wavelength in a range from 800 nm to 1 mm), or in the ultraviolet range (having a wavelength is a range from 10 nm to 400 nm). The light emitting devices of the present disclosure include light emitting devices as known in the art, and particularly the semiconductor light emitting diodes (LEDs) emitting light in the visible range.

As used herein, a “light emitting device assembly,” or an “LED assembly” refers to an assembly in which at least one light emitting device, such as at least one LED, is structurally fixed with respect to a support structure, which can include, for example, a substrate, a matrix, or any other structure configured to provide stable mechanical support to the at least one light emitting device.

As used herein, a “light bar” refers to a light emitting device assembly and supporting electrical and structural elements that structurally supports the light emitting device assembly and provides electrical wiring used for operation of the light emitting device assembly.

As used herein, a “light guide unit” refers to a unit configured to guide light emitted from at least one light emitting device in a light emitting device assembly in a direction or directions that are substantially different from the initial direction of the light as emitted from the at least one light emitting device. A light guide unit of the present disclosure may be configured to reflect or scatter light along a direction different from the initial direction of the light as emitted from the at least one light emitting device. In one embodiment, the light guide unit of the present disclosure includes a light guide plate, and may be configured to reflect light along directions about the surface normal of the bottom surface of the light guide plate, i.e., along directions substantially perpendicular to the bottom surface of the light guide plate. An integrated back light unit can include a combination of a light bar, a light guide unit, and optional components that structurally support the light bar and the light guide unit. As used herein, a direction is “substantially perpendicular” to another direction if the angle between the two directions is in a range from 75 degrees to 105 degrees.

Embodiments are drawn to a light emitting device which includes a light emitting diode (LED) assembly with a support having an interstice and at least one LED located in the interstice and a transparent material encapsulating the at least one LED and which forms at least part of an optical launch and/or a waveguide. In other words, the LED die encapsulant forms the optical launch and/or the waveguide, such as a light guiding plate. Other embodiments are drawn to an integrated back light unit which includes the optical launch and a back light waveguide optically coupled to the optical launch. Preferably, the back light waveguide directly contacts the transparent material. Other embodiments are drawn to methods of making light emitting devices and integrated back light units. Embodiments of the method of making an integrated back light unit include making a light emitting device by attaching at least one LED in an interstice located in a support and encapsulating the at least one LED with a transparent material which forms at least part of an optical launch and/or a waveguide. In one embodiment, the method of making an integrated back light unit also includes optically coupling a back light waveguide to the optical launch. Preferably, the back light waveguide directly contacts the transparent material.

This integrated back light unit architecture eliminates the first-level packaging of LED emitters and allows very efficient optical launch of emitted photons into the waveguide, such as a light guide plate without the in-package and coupling losses associated with conventional architectures of back light units for display and illumination applications. This provides the direct coupling of the light guide plate to the LED emitters by co-molding that eliminates or reduces undesirable optical interfaces.

As used herein, “red light” refers to light having a wavelength in a range from 620 nm to 750 nm. A “red-light-emitting diode,” a “red-light-emitting LED,” or a “red diode” refers to a diode having a peak emission wavelength in a range from 620 nm to 750 nm.

As used herein, “green light” refers to light having a wavelength in a range from 495 nm to 570 nm. A “green-light-emitting diode,” a “green-light-emitting LED,” or a “green diode” refers to a diode having a peak emission wavelength in a range from 495 nm to 570 nm.

As used herein, “blue light” refers to light having a wavelength in a range from 400 nm to 495 nm. A “blue-light-emitting diode,” a “blue-light-emitting LED,” or a “blue diode” refers to a diode having a peak emission wavelength in a range from 400 nm to 495 nm.

An integrated back light unit can include a light guide plate and a light bar. The light bar includes a light emitting device assembly, such as an LED assembly, which includes a periodic array of multiple types of light emitting devices (e.g., LEDs). The multiple types of light emitting devices can include first color light emitting LEDs (i.e., first-type light emitting devices), second color light emitting LEDs (i.e., second-type light emitting devices), and third color light emitting LEDs (i.e., third-type light emitting devices). Multiple instances of the set of a first-type light emitting device, a third-type light emitting device, and a second-type light emitting device are repeated along the lengthwise direction of the LED assembly 300.

Electrical wiring can be provided to provide electrical power to light emitting devices in the LED assembly. The electrical wiring can be provided, for example, by a printed circuit board (PCB), which may be, for example, flexible circuit board (FCB). Electrical connectors can be provided at one side of the light bar to provide an interface between the electrical wires on the PCB and a power supply socket to which the light bar is mounted. The light guide unit is optically coupled to the light emitting devices, and is configured to reflect light from light emitting devices to provide illumination over an area, which is the illumination are of the integrated back light unit.

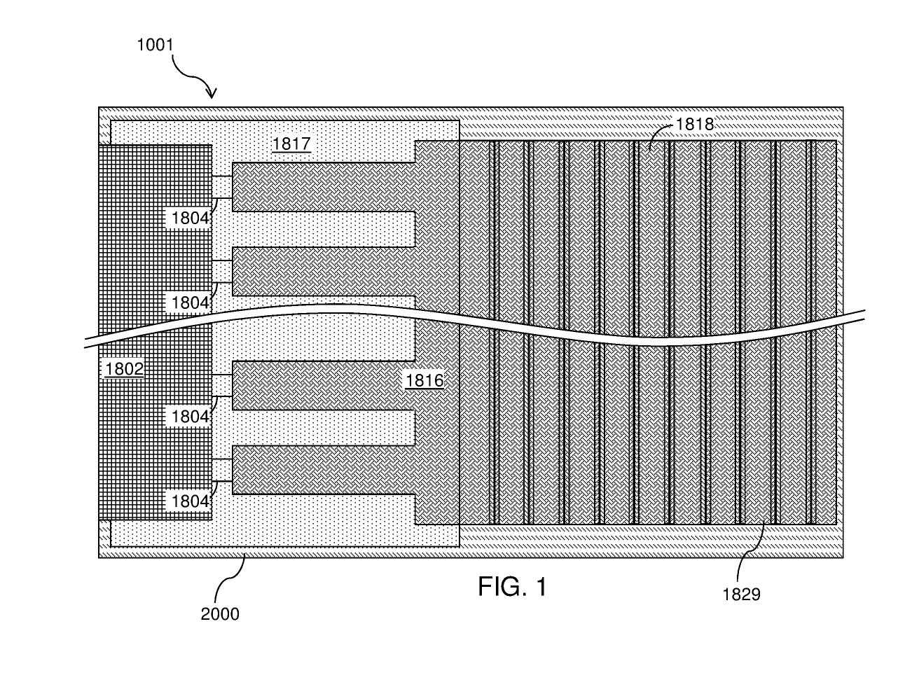

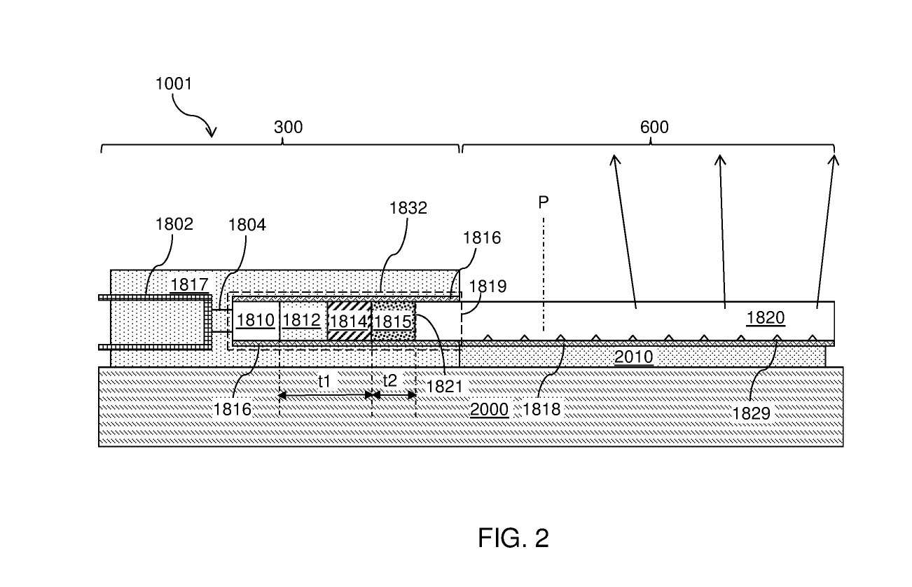

Referring to FIGS. 1 and 2, a first exemplary integrated back light unit 1001 is shown, which includes a light emitting device assembly 300, a light guide unit 600, and a substrate 2000. The light emitting device assembly 300 can be a light bar or a different device assembly. The substrate 2000 can be an insulator substrate, a semiconductor substrate, a conductive substrate, or a combination or a stack thereof, and can be replaced with any rigid structure that can provide structural support to the light emitting device assembly. The substrate 2000 can be an optional component.

The light emitting device assembly 300 can include a support (1817, 1802, 1804) having a shape that defines an interstice 1832 therein. The interstice 1832 is a cavity having an opening 1819 toward a side. The interstice 1832 cavity can be a space in the encapsulating material that is occupied by the LEDs. Alternatively, if the light emitting device assembly 300 contains a reflector (e.g., reflective material layer 1816), then the interstice 1832 can be a cavity in the reflector with the opening 1819 toward the side facing light guide unit 600. In one embodiment, the interstice 1832 can have a uniform width in proximity to the opening 1819 at the side, and can have as many number of cavity extensions away from the opening 1819 as the number of light emitting devices 1810 (e.g., LEDs) to be embedded within the support (1817, 1802, 1804). Alternately, the number of cavity extensions can be the same as the number of clusters of light emitting devices 1810 if a plurality of the light emitting devices 1810 are bundled as a cluster. Yet alternately, the cavity extensions can be merged in case the light emitting devices 1810 laterally contact one another within the interstice 1832.

In one embodiment, the portion of the interstice 1832 that is proximal to the opening 1819 can contain a substantially rectangular cavity having a uniform width. In another embodiment, the portion of the interstice 1832 that is proximal to the opening 1819 can be corrugated such that the light guide unit 600 may be inserted into the interstice with precision alignment. The shape of the interstice 1832 can be adjusted to accommodate the type, the shape, and the nature of each of the at least one light emitting device 1810. In an illustrative example, the interstice 1832 may include portions having a slit shape, a cylindrical shape, a conical shape, a polyhedral shape, a pyramidal shape, or any three-dimensional curvilinear shape to accommodate embedding of the at least one light emitting device 1810, to accommodate a light path between each of the at least one light emitting device 1810 and the opening 1819 of the interstice 1832, and to accommodate insertion of a portion of the light guide unit 600 into the interstice 1832.

An optional source-side reflective material layer 1816 can be formed on at least a portion of the sidewalls of the interstice 1832. The source-side reflective material layer 1816 can be a layer of a light-reflecting material such as a silver or aluminum. In one embodiment, the source-side reflective material layer 1816 can be formed as a coating. Alternatively, the source-side reflective material layer can be formed only on the light emitting device 1810, such as an LED, to form the “bottom” of the interstice 1832 but not the sidewalls of the interstice 1832. In this case, the encapsulating matrix 1817 and/or the transparent encapsulant portion 1812 may form the sidewalls of the interstice 1832 containing the light emitting device 1810.

The support (1817, 1802, 1804) can include a lead structure 1802 that can be a molded lead frame, a circuit board (e.g. printed circuit board of the first embodiment), or any structure that can house the power supply wiring to each of the at least one light emitting device 1810. Further, the support (1817, 1802, 1804) can include leads 1804 that provide electrical connection from the lead structure 1802 to the various nodes of the at least one light emitting device 1810. The support (1817, 1802, 1804) can further include an encapsulating matrix 1817, which can be molded to form the interstice 1832 therein. In one embodiment, the encapsulating matrix 1817 can be a plastic material or a polymer LED package made of an opaque material or an optically transparent material. As used herein, an “optically transparent material” refers to a material that is at least 50% transmissive at the wavelength of the light emitted from the at least one light emitting device 1810. As used herein, an “opaque material” refers to any material that is not an optically transparent material. A housing (not shown) may be provided for the encapsulating matrix 1817 as needed.

Each of the at least one light emitting device 1810 can be located in the interstice 1832 and embedded within the support (1817, 1802, 1804) such that the electrically active nodes of the at least one light emitting device 1810 contact the leads 1804. Each light emitting device 1810 can be electrically connected to the leads 1804 in any suitable technique for bonding or attachment such as flip chip bonding or wire bonding. The encapsulating matrix 1817 of the support is then formed over the light emitting device 1810. In one embodiment, each of the at least one light emitting device 1810 may include one or more light-emitting semiconductor elements (such as red, green and blue emitting LEDs; blue LEDs, green LEDs, and blue LEDs covered with red emitting phosphor; or blue LEDs, green LEDs, and blue emitting LEDs covered with yellow emitting phosphor).

In one embodiment, the at least one light emitting device 1810 can include a white light emitting LED (e.g., a blue LED covered with yellow emitting phosphor which together appear to emit white light to an observer) or plurality of closely spaced LEDs (e.g., a set of closely spaced LEDs emitting red, green, and blue light; a set of closely spaced LEDs including a blue LED, a green LED, and a blue LED covered with red emitting phosphor; or a set of closely spaced LEDs including a blue LED, a green LED, and a blue LED covered with yellow emitting phosphor).

Any suitable LED structure may be utilized for each of the at least one light emitting device 1810. In embodiments, the LED may be a nanowire-based LED. Nanowire LEDs are typically based on one or more pn- or pin-junctions. Each nanowire may comprise a first conductivity type (e.g., doped n-type) nanowire core and an enclosing second conductivity type (e.g., doped p-type) shell for forming a pn or pin junction that in operation provides an active region for light generation. An intermediate active region between the core and shell may comprise a single intrinsic or lightly doped (e.g., doping level below 10¹⁶ cm⁻³) semiconductor layer or one or more quantum wells, such as 3-10 quantum wells comprising a plurality of semiconductor layers of different band gaps. Nanowires are typically arranged in arrays comprising hundreds, thousands, tens of thousands, or more, of nanowires side by side on the supporting substrate to form the LED structure. The nanowires may comprise a variety of semiconductor materials, such as III-V semiconductors and/or III-nitride semiconductors, and suitable materials include, without limitation GaAs, InAs, Ge, ZnO, InN, GaInN, GaN, AlGaInN, BN, InP, InAsP, GaInP, InGaP:Si, InGaP:Zn, GaInAs, AlInP, GaAlInP, GaAlInAsP, GaInSb, InSb, MN, GaP and Si. The supporting substrate may include, without limitation, III-V or II-VI semiconductors, Si, Ge, Al₂O₃, SiC, Quartz and glass. Further details regarding nanowire LEDs and methods of fabrication are discussed, for example, in U.S. Pat. Nos. 7,396,696, 7,335,908 and 7,829,443, PCT Publication Nos. WO20100014032, WO20008048704 and WO200071802781, and in Swedish patent application SE 1050700-2, all of which are incorporated by reference in their entirety herein.

Alternatively, bulk (i.e., planar layer type) LEDs may be used instead of or in addition to the nanowire LEDs. Furthermore, while inorganic semiconductor nanowire or bulk light emitting diodes are preferred, any other light emitting devices may be used instead, such as laser, organic light emitting diode (OLED) (including small molecule, polymer and/or phosphorescent based OLED), light emitting electrochemical cell (LEC), chemiluminescent, fluorescent, cathodoluminescent, electron stimulated luminescent (ESL), resistive filament incandescent, halogen incandescent, and/or gas discharge light emitting device. Each light emitting device 1810 may emit any suitable radiation wavelength (e.g., peak or band), such as visible radiation.

An optically transparent encapsulant portion 1812 can be formed on each of the at least one light emitting device 1810 within the interstice 1832. If the encapsulating matrix 1817 is optically transparent and the source-side reflective material layer 1816 is omitted or not formed on the sidewalls of the interstice 1832, then the optically transparent encapsulant portion 1812 can be a part of the encapsulating matrix 1817 located between the light emitting device 1810 and the light guide unit 600. In this case, the optically transparent encapsulant portion 1812 can be a part of the encapsulating matrix 1817 comprise the same optically transparent material (e.g., epoxy, silicone, or polymer) and are formed in the same encapsulation step over the light emitting device 1810.

In one embodiment, each optically transparent encapsulant portion 1812 can include a transparent dielectric material such as heat cured silicone. Silicone is a polymer derived from polymerizing repeating units of siloxane, which is a functional group of two silicon atoms and one oxygen atom and optionally combined with carbon and/or hydrogen. Heat cured silicone is silicone that can be cured by applying heat, which can be typically in a range from 90 degrees Celsius to 150 degrees Celsius. Heat cured silicone can be applied in an uncured form after the at least one light emitting device 1810 is disposed in the interstices 1832, and can be subsequently cured by applying heat to provide the optically transparent encapsulant portions 1812 that include heat cured silicone in a cured form. The optically transparent encapsulant portions 1812 adhere to a respective light emitting device 1810 and to the encapsulating matrix 1817. The optically transparent encapsulant portions 1812 can encapsulate, and can attach bars of arrays of red, green and blue (RGB) light-emitting diodes (LED) on to light guide plates (LGP) in various edge-lit displays.

In one embodiment, light-scattering particles can be embedded into the material of the optically transparent encapsulant portions 1812. The light-scattering particles, also referred to as diffusers, act to effectively mix the light ray bundles emitted from the individual RGB LED emitters entering the LGP, effectively mixing the colors together so that the bar of LEDs and LGP can be assembled into a back light unit that produces a uniform color temperature and brightness. In one embodiment, the diffusers can be mixed into the material of the optically transparent encapsulant portions 1812 at a concentration that can be selected to optimize the ray-bundle mixing of the arrays of RGB emitters without excessively attenuating the intensities of the emission. In one embodiment, the volume fraction of the light-scattering particles in portions 1812 may be in a range from 1.0×10⁻⁹ to 1.0×10⁻³, and/or may be in a range from 1.0×10⁻⁷ to 1.0×10⁻⁵, although lesser and greater volume fractions can also be employed. Alternatively, the optically transparent encapsulant portions 1812 can be free of light-scattering particles.

The size and composition of the particles used for scattering, if employed, can be selected to optimize the optical properties of the optically transparent encapsulant portion 1812. In one embodiment, titanium oxide (TiO₂) particles can be as the diffusers for LED sources. In one embodiment, the average size (e.g., a diameter) of the diffuser particles can be in a range from 0.5 micron to 10 microns, although lesser and greater sizes can also be employed. As used herein, a “size” of a particle refers to a diameter of a sphere having a same volume as the particle. As used herein, an “average size” of particles refers to the average of the sizes of the particles. In one embodiment, silicone can be employed as the matrix material of the optically transparent encapsulant portion, which functions as an adhesive and an encapsulant material for the diffuser particles.

At least one optical launch 1814 can be formed on a subset of the optically transparent encapsulant portions 1812. In one embodiment, an optical launch 1814 can be formed on each optically transparent encapsulant portion 1812. In another embodiment, optical launches 1814 can be formed on a subset of the optically transparent encapsulant portion 1812, and not formed on a complementary subset of the optically transparent encapsulant portions 1812. Each optical launch 1814 may include a phosphor or dye material mixed in with the silicone, polymer, and/or epoxy.

In one embodiment, light-scattering particles can be embedded into the material of the optical launches 1814. The light-scattering particles, also referred to as diffusers, act to effectively mix the light ray bundles emitted from the individual RGB LED emitters entering the LGP, effectively mixing the colors together so that the bar of LEDs and LGP can be assembled into a back light unit that produces a uniform color temperature and brightness. In one embodiment, the diffusers can be mixed into the material of the optical launches 1814 at a concentration that can be selected to optimize the ray-bundle mixing of the arrays of RGB emitters without excessively attenuating the intensities of the emission. In one embodiment, the volume fraction of the light-scattering particles in launches 1814 may be in a range from 1.0×10⁻⁹ to 1.0×10⁻³, and/or may be in a range from 1.0×10⁻⁷ to 1.0×10⁻⁵, although lesser and greater volume fractions can also be employed. Alternatively, the optical launches 1814 can be free of light-scattering particles.

The size and composition of the particles used for scattering in each optical launch 1814, if employed, can be selected to optimize the optical properties of the respective optical launch 1814. In one embodiment, titanium oxide (TiO₂) particles can be as the diffusers for LED sources. In one embodiment, the average size (e.g., a diameter) of the diffuser particles can be in a range from 0.5 micron to 10 microns, although lesser and greater sizes can also be employed. In one embodiment, silicone can be employed as the matrix material of the optical launches 1814, which functions as an adhesive and an encapsulant material for the diffuser particles.

The lateral thickness t1 of the combination of the optically transparent encapsulation portions 1812 and the optical launches 1814 (which is herein referred to a first lateral thickness), as measured along the primary direction of light propagation (which is a horizontal direction), may be in a range from 100 microns to 1,600 microns, and/or may be in a range from 200 microns to 800 microns, and/or may be in a range from 400 microns to 600 microns, although lesser and greater first lateral thicknesses can also be employed.

Each of the encapsulating matrix 1817 and the optically transparent encapsulant portion(s) 1812 and the optical launches 1814 can be at least 80% transmissive at the wavelength(s) of the light emitted from the at least one light emitting device 1810. In one embodiment, each of the encapsulating matrix 1817, the optically transparent encapsulant portion(s) 1812 and the optical launches 1814 can be 80%-99% transmissive at the wavelength(s) of the light emitted from the at least one light emitting device 1810. In one embodiment, each of the encapsulating matrix 1817, the optically transparent encapsulant portion(s) 1812 and the optical launches 1814 can be 80%-99% transmissive over the visible wavelength range. In an illustrative example, the materials for the encapsulating matrix 1817, the optically transparent encapsulant portion(s) 1812 and the optical launches 1814 may be independently selected from silicone, acrylic polymer (e.g., poly(methyl methacrylate) (“PMMA”), and epoxy. In one embodiment, the encapsulating matrix 1817, the optically transparent encapsulant portion(s) 1812 and the optical launches 1814 can comprise the same material that is formed at the same time over the light emitting devices 1810. In one embodiment, a light bar may be used as the light emitting device assembly 300 of the present disclosure.

The light guide unit 600 includes a light guiding plate 1820 plurality of extraction features 1829 configured to reflect or scatter light from the at least one light emitting device 1810. The plurality of light extraction features 1829 reflect or scatter light to the front side of the light guide unit 600. The general directions along which the light from the at least one light emitting device 1810 is reflected or scattered is illustrated by the three upward-pointing arrows in FIG. 2.

In one embodiment, the light guide unit 600 can include a light guide plate 1820, which can be an optically transparent plate having a substantially uniform thickness. In one embodiment, the plurality of extraction features 1829 may be located on a surface or, or within, the light guide plate 1820. In one embodiment, the plurality of extraction features 1829 can be geometrical features on the bottom surface of the light guide plate 1820. The geometrical features can include, for example, protrusions and/or recesses on the bottom surface of the light guide plate 1820. In one embodiment, each of the geometrical features can have, for example, a prism shape, a pyramidal shape, a columnar shape, a conical shape, or a combination thereof. The geometrical features may be discrete features not adjoined to one another, or may be adjoined to one another to form a contiguous structure. In one embodiment, a dimension of each geometrical feature along the direction of the initial direction of the light rays can be in a range from ¼ of the wavelength of the light emitted from the at least one light emitting device 1810 to about 1000 times the wavelength of the light emitted from the at least one light emitting device 1810, although lesser and grater dimensions can also be employed.

The plurality of extraction features 1829 can be printed geometrical features on a surface of the light guide plate 1820 to affect the extraction and transmission of photons traveling within the light guide plate 1820. The printed feature can be optimized to absorb, reflect, or partially reflect and absorb the photons from the at least one light emitting device 1810. The at least one of the printed geometrical features may have a shape selected from a rectilinear shape, a curvilinear shape, a polygonal shape, and a curved shape, and may be optimized to obtain a desired optical emission pattern from the surface of the light guide plate 1820. Inkjetting, stenciling or other suitable pattern transferring process can form the desired geometrical features of the extraction features 1829. A suitable polymer-based or solvent-based carrier can deliver the desired material for the plurality of extraction features 1829 to the surface of the light guide plate 1820. The delivered material of the plurality of extraction features 1829 can be absorptive, reflective, or partially transmissive.

The light guide unit 600 can further include a backside light reflection layer 1818, which is a light reflection layer positioned on the bottom side of the light guide plate 1820. The backside light reflection layer 1818 functions as a back plate that underlies the light guide plate 1820, and reflects light from the at least one light emitting device 1000 to the front side of the light guide unit 600. The backside light reflection layer 1818 can be a layer of a light-reflecting material such as silver or aluminum, or a coating of a light-reflecting material on a flexible or non-flexible layer. In one embodiment, the backside light reflection layer 1818 can include a thermally conductive material such as metal. In one embodiment, a thermally conductive layer 2010 can be provided between the backside light reflection layer 1818 and the substrate 2000 to facilitate heat transfer from the backside light reflection layer 1818 to the substrate 2000 so that overheating of the backside light reflection layer 1818 is avoided.

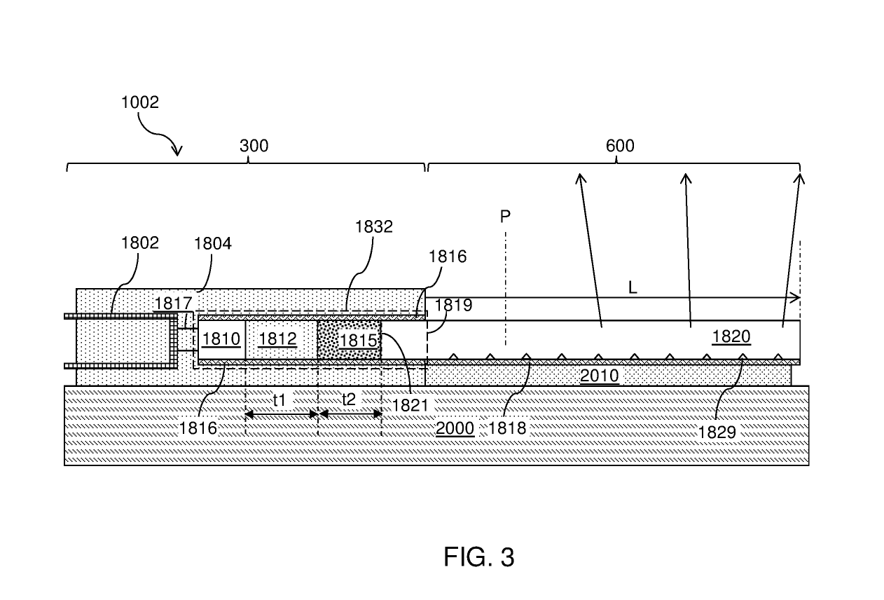

The light guide unit 600 is optically coupled to the at least one blue-light-emitting light emitting device 1810. The light guide unit 600 can be inserted into the interstice 1832, or its edge can be positioned next to the opening 1819 of the respective interstice 1832 or adjacent to the optically transparent encapsulant portion 1812 and/or the optical launch 1814 of the light emitting device 1810. In one embodiment, the thickness of the light guide unit 600 and the width of the interstice 1832 can be substantially the same. Alternatively, the width of the interstice 1832 can be less than the thickness of the light guide unit 600 be an offset in a range from 0.001 micron to 5 micron for a tight fit upon insertion, although lesser and greater offsets can also be employed. In one embodiment the thickness of the light guide unit 600 may be in a range from 0.2 mm to 0.8 mm, and/or may be in a range from 0.3 mm to 0.6 mm, and/or may be in a range from 0.4 mm to 0.5 mm, although lesser and greater thicknesses can also be employed. While a configuration in which the light guide unit 600 is inserted into the interstice 1832 is illustrated in FIGS. 2 and 3, in an alternative embodiment the light guide unit 600 is placed adjacent to the interstice 1832 in any manner provided that the optical coupling is provided between the at least one light emitting device 1810 and the light guide unit 600. Generally, at least a distal portion of the light guide unit 600 extends outside the interstice 1832.

In one embodiment, a first portion of the light guide unit 600 can be flexibly positioned within the interstice 1832, and a second portion of the light guide unit 600 extends outside the interstice 1832. In one embodiment, the second portion of the light guide unit 600 can protrude out of the interstice 1832. The first portion of the light guide unit 600 is herein referred to as a proximal portion of the light guide unit 600, and the second portion of the light guide unit 600 is herein referred to as a distal portion of the light guide unit 600.

Prior to coupling the light guide unit 600 to the light emitting device assembly 300, an adhesive material (e.g., adhesive epoxy or two sided adhesive tape) can be applied to a proximal sidewall of the light guide unit 600 that is the most proximate to the light emitting devices 1810 and/or to a physically exposed distal sidewall of each optical launch 1814. If an optical launch 1814 is not employed for one or more of the light emitting devices 1810 as will be described in more detail below with respect to FIG. 3, the adhesive material can be applied to each physically exposed distal sidewall of the optically transparent encapsulant portions 1812. Upon assembly of the light guide unit 600 and the light emitting device assembly 300 with the adhesive material therebetween, the adhesive material can be cured (e.g., if made of epoxy) or pressed to adjacent parts (e.g., if made of two sided adhesive tape) to form an adhesive material portion 1815, which is bonded to distal sidewalls of the optical launches 1814 and, if the optical launch is not employed for one or more of the light emitting devices 1810, to the distal sidewalls of the optically transparent encapsulant portions 1812. The adhesive material portion 1815 is bonded to the proximal sidewall surface 1821 of the light guide plate 600 and the distal sidewalls of the optical launches 1814 and optionally to the distal sidewalls of the optically transparent encapsulant portions 1812 (if an optical launch is not provided for the corresponding light emitting device 1810).

The lateral thickness t2 of the combination of the adhesive material portion 1815 (which is herein referred to a second lateral thickness), as measured along the primary direction of light propagation, may be in a range from 25 microns to 400 microns, and/or may be in a range from 50 microns to 200 microns, and/or may be in a range from 100 microns to 150 microns, although lesser and greater first lateral thicknesses can also be employed.

In one embodiment, the adhesive material portion 1815 includes ultraviolet radiation cured silicone, i.e., silicone that can be, or has been, cured by ultraviolet radiation. Thus, an ultraviolet radiation cured silicone material in uncured form can be applied as the adhesive material prior to assembly of the light guide plate 600 and the light emitting device assembly 300, and ultraviolet radiation can be applied to the adhesive material to form the adhesive material portion 1815 that includes ultraviolet cured silicon in cured form.

In an alternative embodiment, the adhesive material portion 1815 includes epoxy. In this case, epoxy in uncured form can be applied as the adhesive material prior to assembly of the light guide plate 600 and the light emitting device assembly 300, and can be subsequently cured to form the adhesive material portion 1815 that includes epoxy in cured form. In an alternative embodiment, the adhesive material portion 1815 comprises a two sided adhesive tape which is adhered to adjacent components by pressing.

In one embodiment, light-scattering particles can be embedded into the adhesive material portion 1815. The light-scattering particles act to effectively mix the light ray bundles emitted from the individual RGB LED emitters entering the LGP, effectively mixing the colors together so that the bar of LEDs and LGP can be assembled into a back light unit that produces a uniform color temperature and brightness. In one embodiment, the diffusers can be mixed into an uncured adhesive material prior to application at a concentration that can be selected to optimize the ray-bundle mixing of the arrays of RGB emitters without excessively attenuating the intensities of the emission. In one embodiment, the volume fraction of the light-scattering particles in portion 1815 may be in a range from 1.0×10⁻⁹ to 1.0×10⁻³, and/or may be in a range from 1.0×10⁻⁷ to 1.0×10⁻⁵, although lesser and greater volume fractions can also be employed. Alternatively, the optical launches 1814 can be free of light-scattering particles.

The size and composition of the particles used for scattering in each optical launch 1814, if employed, can be selected to optimize the optical properties of the respective optical launch 1814. In one embodiment, titanium oxide (TiO₂) particles can be as the diffusers for LED sources. In one embodiment, the average size (e.g., a diameter) of the diffuser particles can be in a range from 0.5 micron to 10 microns, although lesser and greater sizes can also be employed. In one embodiment, silicone can be employed as the matrix material of the optically transparent adhesive material portion 1815, which functions as an adhesive and an encapsulant material for the diffuser particles.

Referring to FIG. 3, a second exemplary integrated back light unit 1002 is shown, which includes a light emitting device assembly 300, a light guide unit 600, and a substrate 2000. The second exemplary integrated back light unit 1002 can be derived from the first exemplary integrated back light unit 1001 by omitting formation of the separate optical launch 1814. In this case, the adhesive material portion 1815 can be formed directly on a sidewall of each optically transparent encapsulant portion 1812, which functions as both an LED encapsulation material and an optical launch.

Use of light-scattering particles in various components of the integrated back light unit of the present disclosure can provide more uniform color-mixed distribution and enhanced optical transmission. The effectiveness of light transmission can be measured by coupling efficiency, which is defined as the ratio of power received through the rays of light at a plane P that is parallel to, and located 4 mm away from, the proximal sidewall surface 1821 of the light guide plate 1820 to the power contained within photons generated from the at least one light emitting device 1810 in the absence of any light extraction features 1829. In an embodiment, the coupling efficiency of the integrated back light unit is at least 65%. As used herein, the term “in the absence of” an element refers to a measurement on a modified structure in which the element is removed. Also, it is understood that the of power received through the rays of light at a plane P that is parallel to, and located 4 mm away from, the proximal sidewall surface 1821 of the light guide plate 1820 can be measured by employing a modified structure in which the length of the light guide plate 1820 is shortened to 4 mm.

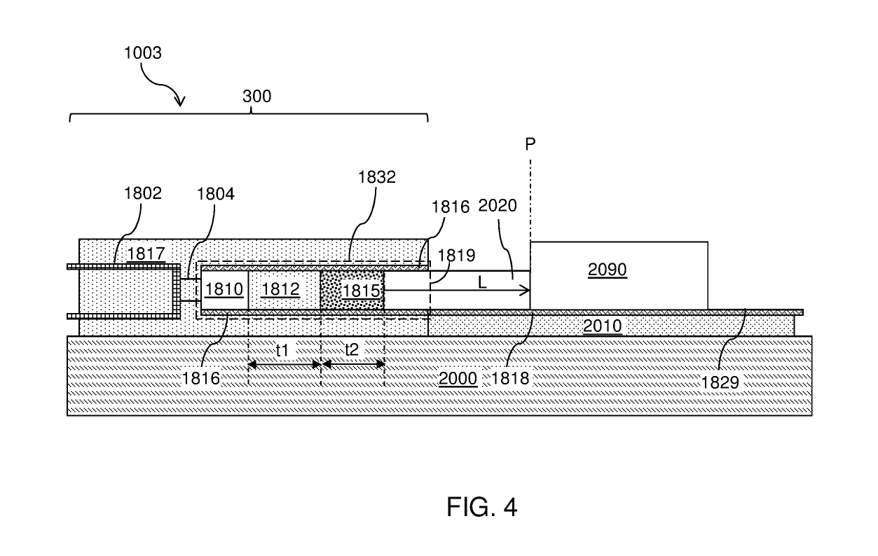

The measurement of the coupling efficiency can be performed by providing a test structure 1003 that is equivalent to the first or second exemplary structures of FIGS. 1-3, and by replacing the light guide plate 1820 with a test light guide plate 2020 that is 4 mm in length L and does not have any extraction features, but is otherwise of the same structure as the corresponding integrated back light unit (1001 or 1002). The test structure 1003 illustrated in FIG. 4 can be identical to the first or second exemplar integrated back light unit (1001 or 1002) except that the test light guide plate 2020 that replaces a respective light guide plate 1820 has a length L of 4 mm and does not have any extraction feature 1829 thereupon. In other words, the coupling efficiency measures the ratio of the amount of photonic energy transmitted to the plane P that is parallel to, and located 4 mm away from, the proximal sidewall surface 1821 of the light guide plate 1820 to the photonic energy generated at the at least one light emitting device 1810 in the absence of any light extraction features 1829 on the light guide plate 1820 on a test structure that has a 4 mm long test light guide plate 2020 and without any extraction feature thereupon, but is otherwise the same as the light guide plate 1820.

In one embodiment, the coupling efficiency of the integrated back light unit of the present disclosure can have a coupling efficiency in a range from 67.5% to 80%. The coupling efficiency provided by the presence of the adhesive material portion 1815 in the integrated back light units of the present disclosure is greater than coupling efficiency that can be provided by integrated back light units that employ an air gap between the light emitting assembly and the light guide plate, which results in a coupling efficiency that is 55% or less, and typically in a range from 40% and 55%. The air gap employed in the prior art, while providing thermal isolation between the light emitting device assembly and the light guide plate in an integrated back light unit, provides an inferior coupling efficiency than the adhesive material portion 1815 of the present disclosure.

Thus, the various embodiments of the present disclosure provide an integrated back light unit (1001 or 1002). The integrated back light unit (1001 or 1002) includes a light emitting device assembly 300 comprising a support (1802, 1804, 1817) containing an interstice 1832 defined within an encapsulating matrix 1817. At least one light emitting device 1810 and at least one optically transparent encapsulant portion 1812 are located in the interstice 1832. The encapsulating matrix 1817 and the at least one optically transparent encapsulant portion 1812 encapsulate the at least one light emitting device 1810 to provide emission of light through the optically transparent encapsulant portion 1812. The integrated back light unit (1001 or 1002) further includes a light guide unit 1820 optically coupled to the at least one light emitting device 1810 to receive light from the at least one light emitting device 1810 and having a proximal sidewall surface 1821. The integrated back light unit (1001 or 1002) may further include an adhesive material portion 1815 bonded to a surface of the light emitting device assembly 300 and the proximal sidewall surface 1821 of the light guide unit 1820.

Optionally, light-scattering particles may be provided within an optical path between the at least one light emitting device 1810 and the light guide unit 600 to diffuse rays of light propagating from the at least one light emitting device 1810 to the light guide unit 600. In one embodiment, the light guide unit 600 includes a plurality of extraction features 1829 configured to reflect light from the at least one light emitting device 1810. In one embodiment, the light-scattering particles may have an average size in a range from 0.5 micron to 10 microns. In one embodiment, the light-scattering particles comprise titanium oxide particles. In one embodiment, at least a subset of the light-scattering particles may be present within the at least one optically transparent encapsulant portion 1812. The integrated back light unit (1001 or 1002) may further include at least one optical launch 1814 comprising at least one of a dye material and a phosphor material and located within the optical path between the at least one light emitting devices 1810 and the light guide unit 1820. In one embodiment, at least a subset of the light-scattering particles may be present in the at least one optical launch. In one embodiment, at least some of the light-scattering particles may be present within the adhesive material portion 1815. In one embodiment, a subset of the light-scattering particles may be present within the at least one optically transparent encapsulant portion 1812.

In one embodiment, the at least one optically transparent encapsulant portion 1812 may include heat cured silicone. In one embodiment, the adhesive material portion 1815 may include ultraviolet radiation cured silicone. In one embodiment, the adhesive material portion 1815 may include epoxy.

In one embodiment, the coupling efficiency, as defined as a ratio of power received through the rays of light at a plane that is parallel to, and located 4 mm away from, the proximal sidewall surface 1821 of the light guide plate 1820 to the power contained within photons generated from the at least one light emitting device 1810 in the absence of any light extraction features 1829 on the light guide plate 1820, of the integrated back light unit (1001 or 1002) is at least 65%. In one embodiment, the coupling efficiency may be in a range from 67.5% to 80%, such as 68% to 71%.

One non-limiting advantage of the embodiments described above with respect to FIGS. 1-3 which contain the above described adhesive layer and light scattering particles in an improvement of at least 20%, such as 20 to 30% in efficacy and power of the device compared to prior art units which have an air gap between the light guide plate and light bar and no scattering particles. The efficacy of the back light unit is a product of: (i) light bar efficiency in Lumens per Watt, (ii) coupling efficiency between the light guide plate and light bar, and (iii) angular light extraction component of the light guide plate. In other words, the embodiment back light unit devices may have the same brightness while consuming 20-30% less power than the prior art devices, or the embodiment back light units may have 20 to 30% more brightness than the prior art devices while consuming the same power as the prior art devices. The embodiment back light units may also have a lower current density (e.g., 3.7 to 4.1 A/cm²) than the prior art devices. For a light bar having an efficiency of 115 L/W and above (e.g. 120 to 150 L/W), the embodiment back light unit system efficacy may be greater than 400 nits, such as 410-500 nits.

Although the foregoing refers to particular preferred embodiments, it will be understood that the disclosure is not so limited. It will occur to those of ordinary skill in the art that various modifications may be made to the disclosed embodiments and that such modifications are intended to be within the scope of the disclosure. Where an embodiment employing a particular structure and/or configuration is illustrated in the present disclosure, it is understood that the present disclosure may be practiced with any other compatible structures and/or configurations that are functionally equivalent provided that such substitutions are not explicitly forbidden or otherwise known to be impossible to one of ordinary skill in the art.

What is claimed is:

1. An integrated back light unit, comprising:
a light emitting device assembly comprising a support containing an encapsulating matrix, at least one light emitting device located on the support, and at least one optically transparent encapsulant portion located on the at least one light emitting device, wherein the encapsulating matrix and the at least one optically transparent encapsulant portion encapsulate the at least one light emitting device, and the at least one light emitting device is configured to provide emission of light through the optically transparent encapsulant portion;
a light guide unit optically coupled to the at least one light emitting device to receive light from the at least one light emitting device and having a proximal sidewall surface; and
an adhesive material portion bonded to a surface of the light emitting device assembly and the proximal sidewall surface of the light guide unit.

2. The integrated back light unit of claim 1, wherein:
the light guide unit comprises a plurality of extraction features configured to reflect light from the at least one light emitting device; and
light-scattering particles are provided within an optical path between the at least one light emitting device and the light guide unit to diffuse rays of light propagating from the at least one light emitting device to the light guide unit.

3. The integrated back light unit of claim 2, wherein the light-scattering particles have an average size in a range from 0.5 micron to 10 microns.

4. The integrated back light unit of claim 3, wherein the light-scattering particles comprise titanium oxide particles.

5. The integrated back light unit of claim 2, wherein at least a subset of the light-scattering particles are present within the at least one optically transparent encapsulant portion.

6. The integrated back light unit of claim 2, further comprising at least one optical launch located within the optical path between the at least one light emitting devices and the light guide unit.

7. The integrated back light unit of claim 6, wherein at least a subset of the light-scattering particles is present in the at least one optical launch.

8. The integrated back light unit of claim 1, wherein the encapsulating matrix and the at least one optically transparent encapsulant portion comprise a same optically transparent material.

9. The integrated back light unit of claim 8, wherein the encapsulating matrix and the at least one optically transparent encapsulant portion comprise a material selected from heat cured silicone, ultraviolet cured silicone, and epoxy.

10. The integrated back light unit of claim 1, wherein the adhesive material portion comprises adhesive tape.

11. The integrated back light unit of claim 9, further comprising a phosphor material located within the optical path between the at least one light emitting devices and the light guide unit.

12. The integrated back light unit of claim 1, wherein coupling efficiency of the integrated back light unit is at least 65%, wherein the coupling efficiency is a ratio of power received through the rays of light at a plane that is parallel to, and located 4 mm away from, the proximal sidewall surface of the light guide plate to power contained within photons generated from the at least one light emitting device in the absence of any light extraction features on the light guide plate.

13. An integrated back light unit, comprising:
a light emitting device assembly comprising a support containing an encapsulating matrix, at least one light emitting device located on the support, and at least one optically transparent encapsulant portion located on the at least one light emitting device, wherein the encapsulating matrix and the at least one optically transparent encapsulant portion encapsulate the at least one light emitting device, and the at least one light emitting device is configured to provide emission of light through the optically transparent encapsulant portion;
a light guide unit optically coupled to the at least one light emitting device to receive light from the at least one light emitting device and having a proximal sidewall surface; and
light-scattering particles provided within an optical path between the at least one light emitting device and the light guide unit to diffuse rays of light propagating from the at least one light emitting device to the light guide unit.

14. The integrated back light unit of claim 13, further comprising an adhesive tape bonded to a surface of the light emitting device assembly and the proximal sidewall surface of the light guide unit.

15. The integrated back light unit of claim 13, wherein the light guide unit comprises a plurality of extraction features configured to reflect light from the at least one light emitting device, and wherein additional light-scattering particles are present within the at least one optically transparent encapsulant portion.

16. The integrated back light unit of claim 13, wherein the encapsulating matrix and the at least one optically transparent encapsulant portion comprise a same optically transparent material.

17. An integrated back light unit, comprising:
a light emitting device assembly comprising a support containing an encapsulating matrix, at least one light emitting device located on the support, and at least one optically transparent encapsulant portion located on the at least one light emitting device, wherein the encapsulating matrix and the at least one optically transparent encapsulant portion encapsulate the at least one light emitting device, and the at least one light emitting device is configured to provide emission of light through the optically transparent encapsulant portion; and
a light guide unit optically coupled to the at least one light emitting device to receive light from the at least one light emitting device and having a proximal sidewall surface,
wherein coupling efficiency of the integrated back light unit is at least 65%, wherein the coupling efficiency is a ratio of power received through the rays of light at a plane that is parallel to, and located 4 mm away from, the proximal sidewall surface of the light guide plate to power contained within photons generated from the at least one light emitting device in the absence of any light extraction features on the light guide plate, of the integrated back light unit is at least 65%.

18. The integrated back light unit of claim 17, wherein the coupling efficiency is in a range from 67.5% to 80%.

19. The integrated back light unit of claim 17, wherein light-scattering particles are provided within an optical path between the at least one light emitting device and the light guide unit to diffuse rays of light propagating from the at least one light emitting device to the light guide unit.

20. The integrated back light unit of claim 17, wherein:
the light guide unit comprises a plurality of extraction features configured to reflect light from the at least one light emitting device; and
the encapsulating matrix and the at least one optically transparent encapsulant portion comprise a same optically transparent material.
